(19) United States
(12) Patent Application Publication
(10) Pub. No.: US 2008/0017629 A1
(43) Pub. Date: Jan. 24, 2008

(54) Steam oven

(75) Inventors: Yaosheng Xu, Xiamen (CN); Shengkai Lin, Xiamen (CN); Yingjie Lu, Xiamen (CN)

Correspondence Address: GREER, BURNS & CRAIN, 300 S WACKER DR, 25TH FLOOR, CHICAGO, IL, 60606, US

(73) Assignee: TSANN KUEN (CHINA) ENTERPRISE CO., LTD.

(21) Appl. No.: 11/825,725

(22) Filed: Jul. 9, 2007

(30) Foreign Application Priority Data
Jul. 18, 2006 (CN) 200610045589.2

(51) Int. Cl. A47J 39/00; A21B 1/08; A47J 36/24

(52) U.S. Cl. 219/401; 126/20; 126/369

(57) ABSTRACT

A steam oven is disclosed. The steam oven includes an oven, a water storing element, a steam generating element, a first conveying element, a second conveying element and a heating element, herein the oven includes an orifice. Both of the water storing element and the steam generating element are disposed adjacent to the oven. The first conveying element used for conveying water from the water storing element to the steam generating element is disposed between the water storing element and the steam generating element. The second conveying element used for conveying steam from the steam generating element to the oven via the orifice connects the steam generating element and the oven. The heating element used for heating steam is disposed adjacent to the second conveying element.

### FIELD OF THE INVENTION

The present invention relates to a steam oven, and more particularly to a steam oven which can produce overheated steam.

### BACKGROUND OF THE INVENTION

A toaster oven used for broiling or heating food has become a ubiquitous appliance in the home. However, the heated food always becomes dry when the food is heated by using the toaster oven. In this condition, the food is generally unappetizing. Therefore, a new steam oven is invented in the market, such as a toaster oven with steam shown in the U.S. Pat. No. 6,100,502, which includes a toaster oven, a water tank, a steam generating chamber, a first water conveying element, a second water conveying element and a control element. In the toaster oven with steam, water in the water tank is conveyed to the steam generating chamber to produce steam via the first water conveying element. Thereinafter, the steam is conveyed to the toaster oven via the second water conveying element to heat the food. Because the food is heated with steam, the problem that the heated food becomes dry is solved.

However, due to health concerns, there is a desirability not only to cook food without making the food become dry but also to remove grease and salt out of the food during cooking. The toaster oven with a general steam cooks the food without removing grease and salt out of the food so that it can not satisfy the actually need for the user.

### SUMMARY OF THE INVENTION

Therefore, an improved steam oven is needed to solve the problem which a conventional steam oven cooks the food without removing grease and salt out of the food, thereby satisfying the health need for the user.

One aspect of the present invention is to provide a steam oven with a heating element adjacent to a second conveying element. An overheated steam is formed via a heating process of the heating element before the steam is conveyed from the second conveying element to the oven. The overheated steam can remove grease and salt out of the food, thereby solving the problem that a general steam cooks the food without removing grease and salt out of the food.

The other aspect of the present invention is to provide a steam oven with a heating element enveloping a second conveying element, herein the heating element includes a conducting element. An overheated steam is formed via a heating process of the heating element before the steam is conveyed from the second conveying element to the oven. The overheated steam can remove grease and salt out of the food, thereby solving the problem that a general steam cooks the food without removing grease and salt out of the food.

To achieve the aforementioned aspects, the present invention provides a steam oven. The steam oven includes an oven, a water storing element, a steam generating element, a first conveying element, a second conveying element and a heating element, herein the oven includes a chamber and a housing of the oven includes an orifice connecting with the chamber. The water storing element used for storing water is disposed adjacent to the oven. The steam generating element used for heating water to become steam is disposed adjacent to the oven. The first conveying element used for conveying water from the water storing element to the steam generating element is disposed between the water storing element and the steam generating element. The second conveying element used for conveying steam from the steam generating element to the chamber of the oven via the orifice connects the steam generating element and the oven. The heating element used for heating steam is disposed adjacent to the second conveying element.

According to the other aspect of the present invention, the present invention provides a steam oven. The steam oven includes an oven, a water storing element, a steam generating element, a first conveying element, a second conveying element and a heating element, herein the oven includes a chamber and a housing of the oven includes an orifice connecting with the chamber. The water storing element used for storing water is disposed adjacent to the oven. The steam generating element used for heating water to become steam is disposed adjacent to the oven. The first conveying element used for conveying water from the water storing element to the steam generating element is disposed between the water storing element and the steam generating element. The second conveying element used for conveying steam from the steam generating element to the chamber of the oven via the orifice connects the steam generating element and the oven. The heating element envelops the second conveying element, herein the heating element used for heating steam in the second conveying element includes a heating element and a conducting element.

According to one embodiment of the present invention, the aforementioned heating element is such as an electrical heat tube, an electrical heat plate or a heating coil.

According to the other embodiment of the present invention, the aforementioned conducting element is such as pure aluminum or aluminum alloy.

With the application of the steam oven of the present invention, a heating element is added on the second conveying element to increase a temperature of steam in the second conveying element. Therefore, compared with other steam ovens, the steam oven of present invention not only can be easily produced but also can produce overheated steam, thereby solving the problem that a general steam can not remove oil and salt out of the food. Besides, the heating element in the present invention further include a conducting element used for transmitting the heat energy produced from the heating element to the second conveying element, thus the effect of using the heat energy from the heating element is increased so as to save energy and the flexibility of the position or amount for arranging the heating element around the second conveying element is increased.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic diagram showing a front view of a steam oven according to a first preferred embodiment of the present invention;

FIG. 1B is a schematic diagram showing a side sectional view of the steam oven shown in FIG. 1A;

FIG. 2 is a schematic diagram showing a side sectional view according to a second preferred embodiment of the present invention; and

FIG. 3 is a schematic diagram showing a side sectional view according to a third preferred embodiment of the present invention.

### DETAILED DESCRIPTION OF THE PREFERRED EMBODIMENT

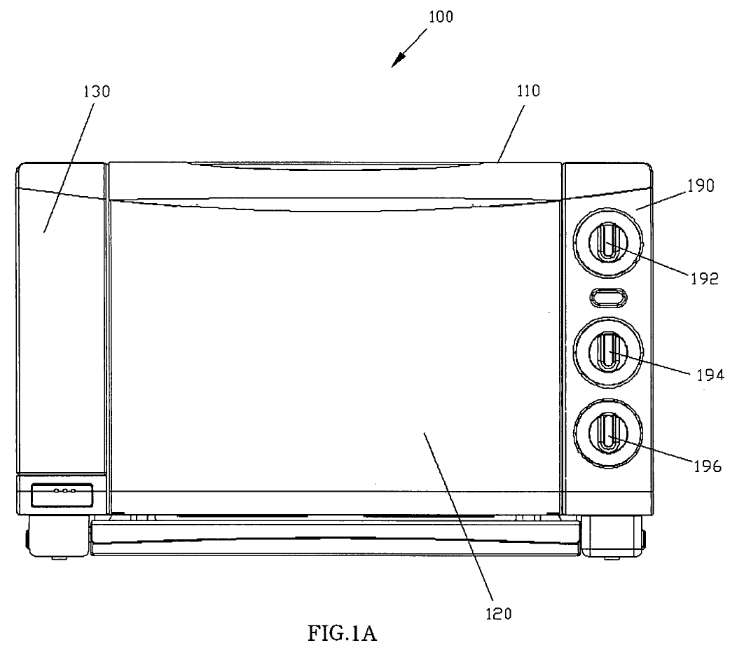

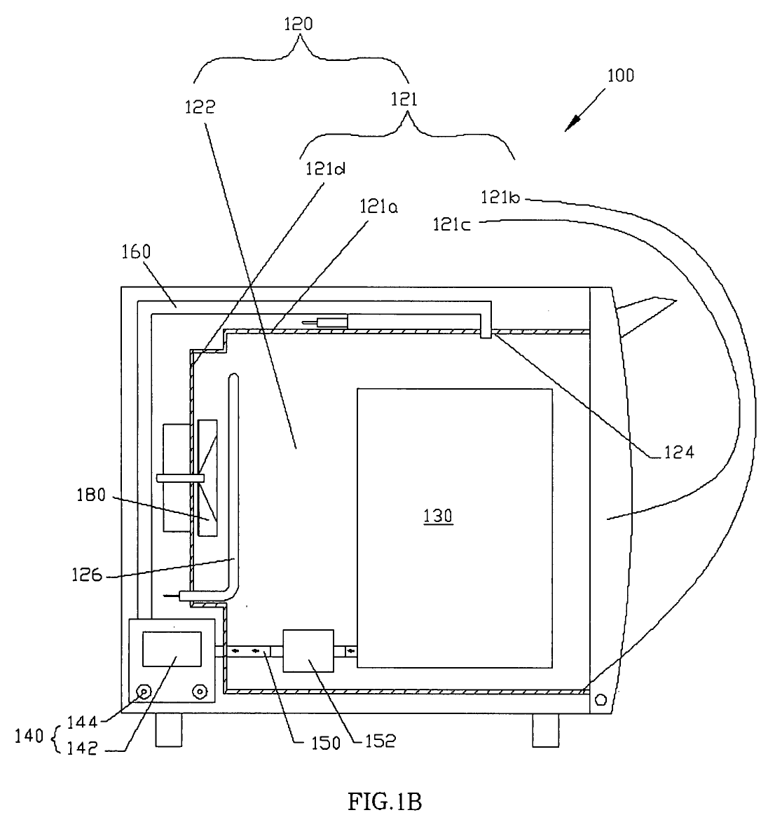

Referring to FIGS. 1A-1B, FIGS. 1A-1B are schematic diagrams respectively showing a front view and a side sectional view of a steam oven according to a first preferred embodiment of the present invention. The steam oven 100 includes a casing 110, an oven 120, a water storing element 130, a steam generating element 140, a first conveying element 150, a second conveying element 160 and a heating element 170, herein the casing 110 encompasses the oven 120, the water storing element 130, the steam generating element 140, the first conveying element 150, the second conveying element 160 and the heating element 170. The oven 120 includes a chamber 122 for receiving the food. A housing 121 of the oven 120 includes an orifice 124 connecting with the chamber 122. In the embodiment, the oven 120 includes a top housing 121a, a bottom housing 121b, a fore housing 121c, a rear housing 121d, a left housing (not shown) and a right housing (not shown), herein the orifice 124 is located at the top housing 121a, without limitation, the orifice 124 also can be located at the other sidewall of the housing 121. The water storing element 130 used for storing water is disposed adjacent to the oven 120. The steam generating element 140 used for heating water to become steam is disposed adjacent to the oven 120, herein the steam generating element 140 includes a hollow shell 142 and at least an electrical heat tube 144. The electrical heat tube 144 is used for heating the hollow shell 142, thereby heating the water conveyed from the water storing element 130 to the hollow shell 142. In the embodiment, the steam generating element 140 is a boiler, without limitation, other heating element with larger heating area and quickly heating water to become steam also can be used. The first conveying element 150 used for conveying water from the water storing element 130 to the steam generating element 140 is disposed between the water storing element 130 and the steam generating element 140. In the embodiment, the first conveying element 150 is a tube. Besides, a control element 152 used for controlling a flow of the water conveyed from the water storing element 130 to the steam generating element 140 is disposed in the first conveying element 150. In the embodiment, the control element 152 is a pump, without limitation, other control valves also can be used. The second conveying element 160 connects the steam generating element 140 and the oven 120, herein the second conveying element 160 is used for conveying the steam from the steam generating element 140 via the orifice 124 of the oven 120 to the chamber 122. In the embodiment, the second conveying element 160 is a tube. The heating element 170 is disposed adjacent to a portion of the second conveying element 160, herein the heating element 170 is used for heating the steam in the second conveying element 160, thereby increasing the temperature of the steam. In the embodiment, the heating element 170 is adjacent to the orifice 124 and disposed on the top housing 121 a of the oven 120, thereby making the steam from the second conveying element 160 to the chamber 122 of the oven 120 via the orifice 124 become overheated steam, without limitation, a position of the heating element 170 can be changed according to the position of the orifice 124 disposed on the housing 121 of the oven 120. Besides, the heating element 170 is an electrical heat tube, without limitation, the heating element 170 also can be an electrical heat plate or a heating coil, which can be adjacent to the second conveying element 160 and transfer the heat energy to the second conveying element 160. In the embodiment, a fan 180 used for forcing air to circulate is disposed in the chamber 122 of the oven 120. Besides, the oven 120 includes at least an electrical heat tube 126 used for heating the food in the chamber 122. Moreover, a control panel 190 is disposed adjacent to the oven 120, herein the control panel 190 includes a control knob 192, 194, 196 to set an operation mode of the oven 120, such as whether a pump or heating element 170 is actuated or whether time or temperature for operation is set.

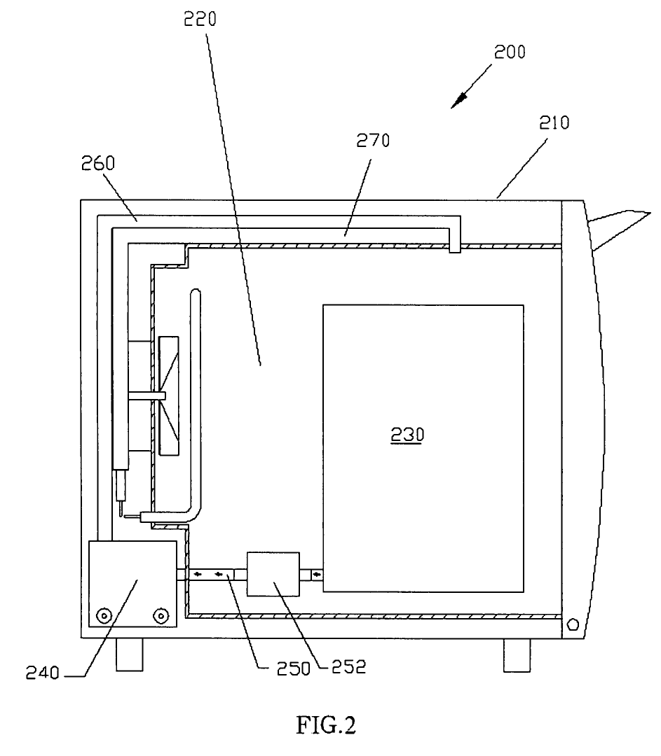

Referring to FIG. 2, FIG. 2. is a schematic diagram showing a side sectional view of a steam oven according to a second preferred embodiment of the present invention. The steam oven 200 includes a casing 210, an oven 220, a water storing element 230, a steam generating element 240, a first conveying element 250, a control element 252, a second conveying element 260 and a heating element 270, herein the casing 210 encompasses the oven 220, the water storing element 230, the steam generating element 240, the first conveying element 250, the second conveying element 260 and the heating element 270. The difference between the steam oven 200 and the steam oven 100 shown in FIG. 1B is that the heating element 270 is disposed adjacent to the whole second conveying element 260. The steam in the whole second conveying element 260 is heated so that the steam will not condense due to a temperature decrease in the second conveying element 260. In the embodiment, the heating element 270 is an electrical heat tube, without limitation, the heating element 270 also can be an electrical heat plate or a heating coil, which can be adjacent to the second conveying element 260 and transfer the heat energy to the second conveying element 260. It is well known that the electrical heat plate or the heating coil can envelop the second conveying element 260 by wrapping method.

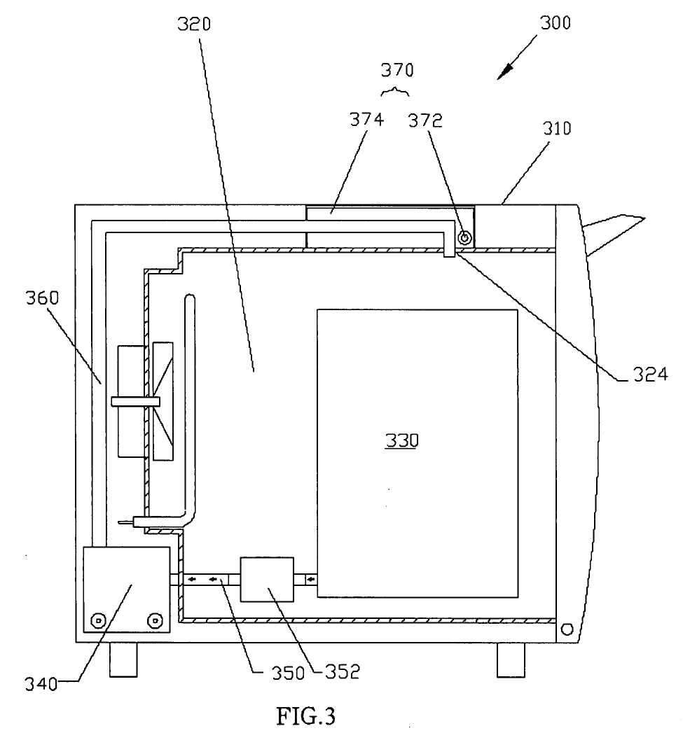

Referring to FIG. 3, FIG. 3. is a schematic diagram showing a side sectional view of a steam oven according to a third preferred embodiment of the present invention. The steam oven 300 includes a casing 310, an oven 320, a water storing element 330, a steam generating element 340, a first conveying element 350, a control element 352, a second conveying element 360 and a heating element 370, herein the casing 310 encompasses the oven 320, the water storing element 330, the steam generating element 340, the first conveying element 350, the control element 352, the second conveying element 360 and the heating element 370. The difference among the steam oven 300 and the steam oven 100 shown in FIG. 1B and the steam oven 200 shown in the FIG. 2 is that the heating element 370 includes a heating unit 372 and a conducting unit 374, which are used for heating steam. In the embodiment, the heating unit 372 is an electrical heat tube, and the conducting unit 374 is a pure aluminum with high conductive effect, without limitation, other heating unit (e.g. heating coil) or conducting unit (e.g. aluminum alloy) also can be used. Because the heating unit 372 is a standard product in the market, it easily causes a condition of manufacture time increase, process yield decrease and process cost increase due to add an additional process treatment for disposing the heating unit 372 adjacent or wrapping the heating unit 372 around the second conveying element 360. Besides, a contacting area between the second conveying element 360 and the heating unit 372 disposed adjacent to or around the second conveying element 360 is not large enough to make most of the heat energy produced from the heating unit 372 lost in the outside environment, thereby making the heating effect of the heating unit 372 worse. Moreover, according to the limitation of the space between the casing 310 and the oven 320 or an increase of the amount of the heating unit 372, sometimes not all of the heating unit 372 can be disposed adjacent to the second conveying element 360. Therefore, in the embodiment, a conducting unit 374 is added to envelop the heating unit 372 and the second conveying element 360, thereby increasing a contacting area between the heating unit 372 and the second conveying element 360. It is well known that a heating element not only can be adjacent to the second conveying element 360 but also can be not adjacent to the second conveying element 360 due to the conducting unit 374. In the embodiment, the heating element 370 envelop a portion of the second conveying element 360 and adjacent to the orifice 324 of the oven 320, without limitation, a position of the heating element 370 can be changed according to the position of the orifice 324 disposed in the oven 320. Besides, the heating element 370 can be designed to envelop the whole the second conveying element 360.

Accordingly, the characteristic structure of the steam oven disclosed in the present invention is that a heating element used for heating the steam in the second conveying element is disposed on the second conveying element, thereby achieving an objective of producing overheated steam so as to solve a problem that a general steam can not remove oil and salt out of the food. Therefore, compared with other steam ovens, the present invention not only can produce overheated steam but also easily be produced in the present steam oven product line due to which a structure of the steam oven of the present invention is similar to the conventional steam oven. Besides, when the heating element of the steam oven of the present invention is not performed in use, a general steam produced by the steam oven of the present invention is almost the same as the conventional steam oven and the heating element dose not cause any harmful effect to the general steam.

According to the preferred embodiment of the present invention, the advantage of the steam oven disclosed in the present invention is that overheated steam can be produced by disposing a heating element on the second conveying element. Therefore, compared with conventional steam ovens, the steam oven of the present invention not only can be easily produced but also can produce overheated steam to solve a problem that a general steam can not remove grease and salt out of the food. Besides, a conducting element disposed in the heating element of the preset invention can transfer the heat energy produced by the heating element to the second conveying element. Thus, the effect of using the heat energy produced from the heating element is increased so as to save energy. At the same time, the flexibility for arranging the heating element around the second conveying element, such as a position of disposing the heating element or amount of the heating element, is increased so as to achieve a desired heating temperature, heating rate or mechanism design.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A steam oven, comprising:
an oven, wherein said oven includes a chamber and a housing of said oven includes an orifice connecting with said chamber;
a water storing element disposed adjacent to said oven, wherein said water storing element is used for storing water;
a steam generating element disposed adjacent to said oven, wherein said steam generating element is used for heating water to become steam;
a first conveying element disposed between said water storing element and said steam generating element, wherein said first conveying element is used for conveying said water from said water storing element to said steam generating element;
a second conveying element connecting said steam generating element and said oven, wherein said second conveying element is used for conveying said steam from said steam generating element to said chamber of said oven via said orifice; and
a heating element disposed adjacent to at least a portion of said second conveying element, wherein said heating element is used for heating said steam.

2. The steam oven of claim 1, further comprising:
a casing encompassing said oven, said water storing element, said steam generating element, said first conveying element, said second conveying element and said heating element.

3. The steam oven of claim 1, wherein said heating element is adjacent to said orifice.

4. The steam oven of claim 3, wherein said heating element is disposed on a top housing of said oven.

5. The steam oven of claim of claim 1, further comprising:
a control element disposed in said first conveying element, wherein said control element is used for controlling a flow of said water conveyed from said water storing element to said steam generating element.

6. The steam oven of claim 5, wherein said control element is a pump.

7. The steam oven of claim 1, wherein said steam generating element comprises a hollow shell and at least an electrical heat tube used for heating said hollow shell.

8. The steam oven of claim 1, wherein said steam generating element is a boiler.

9. The steam oven of claim 1, further comprising:
a fan disposed in said chamber of said oven, wherein said fan is used for circulating air.

10. A steam oven, comprising:
an oven, wherein said oven includes a chamber and a housing of said oven includes an orifice connecting with said chamber;
a water storing element disposed adjacent to said oven, wherein said water storing element is used for storing water;
a steam generating element disposed adjacent to said oven, wherein said steam generating element is used for heating water to become steam;
a first conveying element disposed between said water storing element and said steam generating element, wherein said first conveying element is used for conveying said water from said water storing element to said steam generating element;
a second conveying element connecting said steam generating element and said oven, wherein said second conveying element is used for conveying said steam from said steam generating element to said chamber of said oven via said orifice; and
a heating element enveloping at least a portion of said second conveying element, wherein said heating element used for heating said steam includes a heating unit and a conducting unit.

11. The steam oven of claim 10, wherein said heating unit of said heating element is adjacent to said second conveying element.

12. The steam oven of claim 10, wherein said conducting unit of said heating element envelops said second conveying element.

13. The steam oven of claim 10, wherein said heating unit is an electrical heat tube.

14. The steam oven of claim 10, wherein said conducting unit is aluminum.

15. The steam oven of claim 10, further comprising:
a casing encompassing said oven, said water storing element, said steam generating element, said first conveying element, said second conveying element and said heating element.

16. The steam oven of claim 10, wherein said heating element is adjacent to said orifice.

17. The steam oven of claim 16, wherein said heating element is disposed on a top housing of said oven.

18. The steam oven of claim of claim 10, further comprising:
a control element disposed in said first conveying element, wherein said control element is used for controlling a flow of said water conveyed from said water storing element to said steam generating element.

19. The steam oven of claim 10, wherein said control element is a pump.

20. The steam oven of claim 10, wherein said steam generating element is a boiler.
